(19) United States
(12) Patent Application Publication
(10) Pub. No.: US 2003/0217173 A1
(43) Pub. Date: Nov. 20, 2003

(54) Automatic proxy detection

(76) Inventors: Alan B. Butt, Orem, UT (US); David A. Jensen, American Fork, UT (US)

Correspondence Address: KENYON & KENYON, 1500 K STREET, N.W., SUITE 700, WASHINGTON, DC, 20005, US

(21) Appl. No.: 10/145,102

(22) Filed: May 15, 2002

(51) Int. Cl. G06F 15/173; G06F 15/16

(52) U.S. Cl. 709/237; 709/225

(57) ABSTRACT

A method of detecting a proxy server includes storing a first copy of a connection table from an Internet Web browser and initiating a request for a Uniform Resource Locator through the Web browser. The method further includes storing a second copy of the connection table from the Internet Web browser while a connection is open and comparing the first copy and the second copy of the connection table.

### FIELD OF THE INVENTION

One embodiment of the present invention is directed to proxy servers. More particularly, one embodiment of the present invention is directed to automatically detecting a proxy server.

### BACKGROUND INFORMATION

Many computers access the Internet via a proxy server. A proxy server is a server that sits between a client application, such as an Internet Web browser, and a real Internet content server. It intercepts all requests to the real server to see if it can fulfill the requests itself. If not, it forwards the request to the real server.

Proxy servers have two main purposes. Proxy servers can improve performance because they save or cache the results of all requests for a certain amount of time. If a request can be met by stored content, there is no need to retrieve the content from the Web server, which results in a faster response time. Proxy servers can also be used to filter request. For example, a company might use a proxy server to prevent its employees from accessing a specific set of Web sites.

For a computer that is coupled to the Internet via a proxy server, all Internet requests must first be directed to the proxy server. When accessing the Internet through an Internet browser, such as the Internet Explorer from Microsoft Corp., the browser is typically set up to detect the browser without user intervention.

However, a problem arises when an application program must communicate directly over the Internet without using the browser or the browser's communication module. For example, some programs directly access the Internet to provide updates. One way for these programs to detect the proxy if to look up the settings for the browser used on the computer. Internet Explorer keeps its proxy settings in the registry in a well-known and documented location. Similar settings are available for Netscape and other Internet browsers. If the proxy location has been manually configured on the browser, no user invention is needed to determine the proxy.

A problem is that one of the possible settings for most browsers is an automatic configuration script or the Web Proxy Autodiscovery Protocol (“WPAD”). In the case of an automatic configuration script, the Web Browser's settings consist of the Uniform Resource Locator (“URL”) where a JavaScript can be found that will determine the actual proxy. WPAD is a protocol in which the URL for the script can be discovered without requiring the URL to be pre-configured. WPAD is now the default setting for Internet Explorer. In either of these cases, the actual proxy is not stored with the settings. Instead, the browser finds the script and executes it every time it needs to connect to a URL. The script contains a method that resolves the proxy for a given URL.

If the above two settings are used in the browser, the program will require manual intervention by the user to determine the proxy. However, many users do not even know what a proxy is, and have great difficulty providing the proper information.

Based on the foregoing, there is a need for a system and method to auto detect a proxy server by a program without user intervention, even when the Internet browser has been set to “automatic” mode for proxy detection.

### BRIEF DESCRIPTION OF THE DRAWINGS

FIG. 1 is an overview diagram of a communication system in accordance with one embodiment of the present invention.

FIGS. 2a and 2b are a flow diagram of the functionality performed by a computer in accordance with one embodiment of the present invention in order to detect a proxy server when accessing a Web site.

### DETAILED DESCRIPTION

One embodiment of the present invention detects a proxy server by comparing the connection table of an Internet browser before and after the browser creates a connection to the proxy. The proxy is detected from the list of differences that result from the comparison.

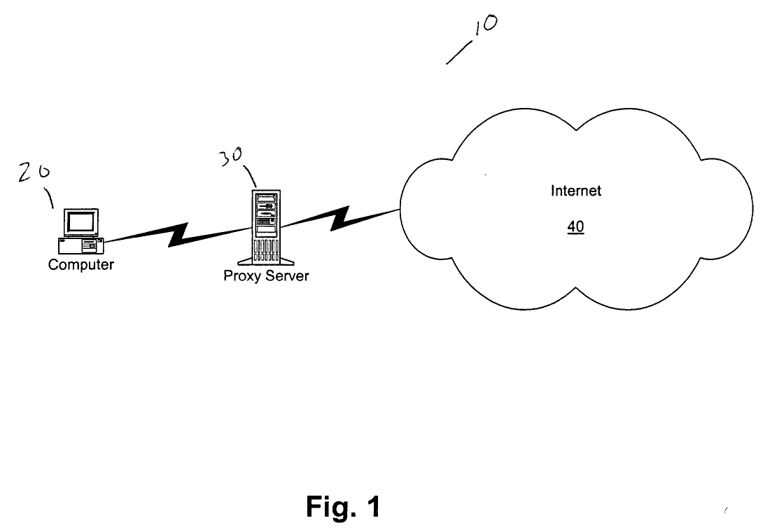

FIG. 1 is an overview diagram of a communication system 10 in accordance with one embodiment of the present invention. System 10 includes a computer 20 coupled to the Internet 40 via a proxy server 30.

Computer 20 may be any type of computer or other device that is capable of accessing Internet 40 and executing software steps. In one embodiment, computer 20 includes a processor, memory and communication interface. Computer 20 executes an operating system and an Internet Web browser, such as the Internet Explorer browser from Microsoft Corp. In one embodiment, the processor is the Pentium 4 processor from Intel Corp. and the operating system is Windows XP from Microsoft Corp. Computer 20 further executes an application program or other function that accesses Internet 40 directly without using the Internet Web browser.

When accessing Internet 40 through its Web browser, computer 20 detects proxy server 30 in a known manner. The Web browser may be manually configured, in which case the proxy can be determined directly. However, if the Web browser is set for Web Proxy Autodiscovery Protocol (“WPAD”), is set to use an automatic configuration script, or is set any other way that does not allow the proxy server to be detected directly, the functionality described below for one embodiment of the present invention can be used by a program executed by computer 20 to detect the proxy server.

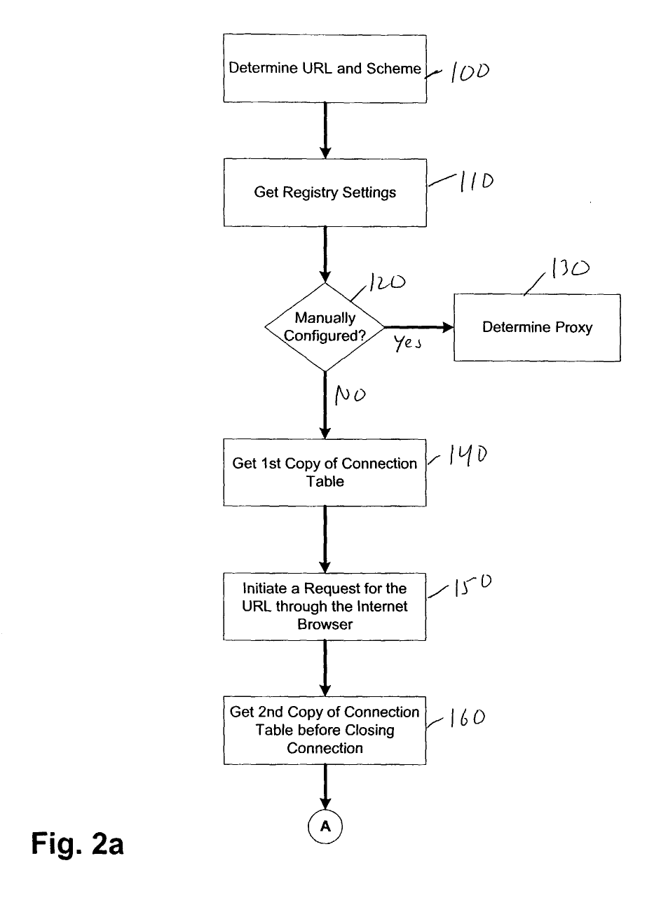

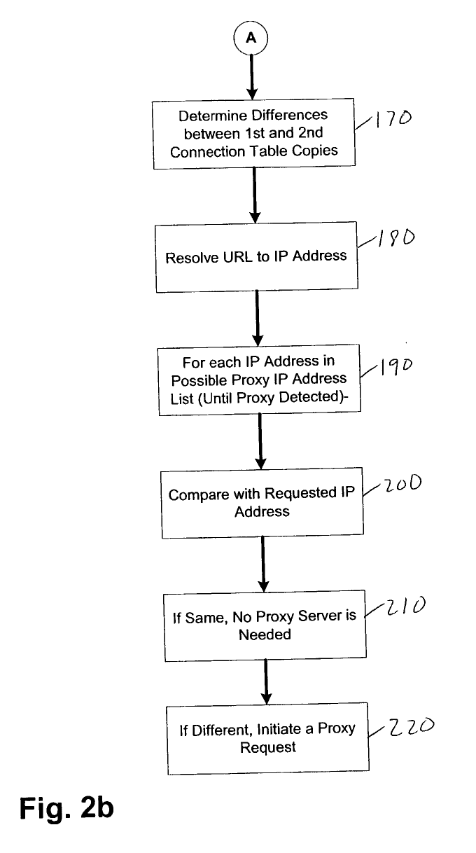

FIGS. 2a and 2b are a flow diagram of the functionality performed by computer 20 in accordance with one embodiment of the present invention in order to detect a proxy server when accessing a Web site. In one embodiment, the functionality is implemented by software stored in memory and executed by a processor. In other embodiments, the functionality can be performed by hardware, or any combination of hardware and software. In one embodiment, the functionality is executed by an application program on computer 20 that is required to access Internet 40 directly without going through an Internet browser on computer 20. In one embodiment, the functionality of the present invention is incorporated into a proxy detection module that may be a software module that is part of, or interfaces with, the application program. The proxy detection module may be stored in the memory of computer 20, and executed by the processor of computer 20.

At box 100, the URL of the Web site that the proxy detection module is trying to access is determined. In one embodiment, this is provided by the application program itself. The scheme or protocol of the URL request is also determined, because the proxy server that the proxy detection module is attempting to detect may vary depending upon the scheme. Examples of possible protocols are HyperText Transfer Protocol (“http”), an SSL http (“https”), File Transfer Protocol (“ftp”), etc.

At box 110, the registry settings or other configuration data for the Internet browser's communication module is determined.

At decision point 120, it is determined whether the proxy server is manually configured on the Internet browser. If it is, then at box 130 the proxy server is determined by reading the information in the browser.

If the proxy server is not manually configured on the Internet browser at decision point 120 (e.g., the Web browser is set for WPAD), then at box 140 a first copy of the Transmission Control Protocol/Internet Protocol (“TCP/IP”) connection table from the Web browser is retrieved and stored by the proxy detection module. In one embodiment, the operating system of computer 20 provides application program interfaces (“APIs”) to obtain the connection table. In another embodiment, a status program such as NETSTAT can be invoked and the output parsed to obtain the connection table.

At box 150, the proxy detection module invokes the Internet browser's communication module and makes a request for the URL that is determined at box 100. This opens up a connection. In one embodiment where the Internet browser is the Internet Explorer, the communication module is WINInet. In one embodiment, the request for the URL is “HEAD”. In other embodiments, the request is “GET” or “POST”, although these types of requests would generate unnecessary data. If the Internet browser is unable to communicate with the URL, the process ends.

At box 160, the proxy detection module retrieves and stores a second copy of the TCP/IP connection table from the Internet browser before the connection that is opened at box 150 is closed. The URL request is then closed and the communication module is released.

At box 170, the differences between the first and second copies of the connection tables are determined. The connection tables include a list of IP addresses. All addresses that are found in both copies are eliminated, and the remaining IP addresses comprise a possible proxy IP address list. In one embodiment, there are typically only 2 or 3 IP addresses that are not common to both connection tables and that form the possible proxy IP address list. In one embodiment, one of the IP addresses on the list is the proxy server address, and one is the address of the host from which the auto proxy script of the Internet browser was loaded.

At box 180, the URL determined at box 100 is resolved (i.e., converted) into its corresponding IP address and port. This allows for an easier comparison of the URL to the list of IP addresses in the communication tables.

For each IP address in the possible proxy IP address list, until the proxy is detected (box 190), the requested IP address at box 180 is compared to an IP address on the possible proxy IP address list (box 200). If there is a match, then at box 210 no proxy server is needed to communicate with the desired host and the process has ended. A proxy server may not be needed because, for example, the URL is on an Intranet that is behind the proxy server.

If there is not a match for a particular IP address at box 210, then the proxy detection module queries the IP address and port by making a valid proxy request (i.e., requests a connection) at box 220. If the request is successful, then the proxy server has been detected and the proxy detection module has determined the proxy's address and port and the process is complete. In one embodiment, one of the IP addresses in the possible proxy address list will result in a successful request unless a proxy is not needed or there is an unknown error.

In another embodiment, at box 220, instead of querying the IP address, the communication program attempts the desired communication assuming that the address is correct. If successful, the query does not have to be performed.

Several embodiments of the present invention are specifically illustrated and/or described herein. However, it will be appreciated that modifications and variations of the present invention are covered by the above teachings and within the purview of the appended claims without departing from the spirit and intended scope of the invention.

What is claimed is:

1. A method of detecting a proxy server comprising:
storing a first copy of a connection table from an Internet Web browser;
initiating a request for a Uniform Resource Locator (URL) through the Web browser;
storing a second copy of the connection table from the Internet Web browser while a connection is open; and
comparing the first copy and the second copy of the connection table.

2. The method of claim 1, further comprising:
forming a list of possible proxy addresses comprising at least one address that is on the second copy of the connection table and not on the first copy of the connection table.

3. The method of claim 1, further comprising:
determining if the Internet Web browser is manually configured.

4. The method of claim 2, further comprising:
resolving the URL to an Internet Protocol address.

5. The method of claim 4, further comprising:
comparing the Internet Protocol address with the list of possible proxy addresses.

6. The method of claim 5, further comprising:
determining if the Internet Protocol address matches any addresses on the list of possible proxy addresses.

7. The method of claim 5, further comprising:
initiating a proxy request to at least one of the addresses on the list of possible proxy addresses.

8. The method of claim 5, further comprising:
assuming that at least one of the addresses on the list of possible proxy addresses is an address of the proxy server.

9. The method of claim 1, wherein the Internet Web browser is set for Web Proxy Autodiscovery Protocol.

10. A computer system comprising:
a processor; and
memory coupled to said processor;
wherein said memory has stored thereon a proxy detection module which, when executed by said processor, causes said processor to:
store a first copy of a connection table from an Internet Web browser;
initiate a request for a Uniform Resource Locator (URL) through the Web browser;
store a second copy of the connection table from the Internet Web browser while a connection is open; and
compare the first copy and the second copy of the connection table.

11. The computer system of claim 10, said proxy detection module further causing said processor to:
form a list of possible proxy addresses comprising at least one address that is on the second copy of the connection table and not on the first copy of the connection table.

12. The computer system of claim 10, said proxy detection module further causing said processor to:
determine if the Internet Web browser is manually configured.

13. The computer system of claim 10, said proxy detection module further causing said processor to:
resolve the URL to an Internet Protocol address.

14. The computer system of claim 13, said proxy detection module further causing said processor to:
compare the Internet Protocol address with the list of possible proxy addresses.

15. The computer system of claim 14, said proxy detection module further causing said processor to:
determine if the Internet Protocol address matches any addresses on the list of possible proxy addresses.

16. The computer system of claim 14, said proxy detection module further causing said processor to:
initiate a proxy request to at least one of the addresses on the list of possible proxy addresses.

17. The computer system of claim 14, said proxy detection module further causing said processor to:
assume that at least one of the addresses on the list of possible proxy addresses is an address of the proxy server.

18. The computer system of claim 10, wherein the Internet Web browser is set for Web Proxy Autodiscovery Protocol.

19. A computer readable medium having instructions stored thereon that, when executed by a processor, cause the processor to:
store a first copy of a connection table from an Internet Web browser;
initiate a request for a Uniform Resource Locator (URL) through the Web browser;
store a second copy of the connection table from the Internet Web browser while a connection is open; and
compare the first copy and the second copy of the connection table.

20. The computer readable medium of claim 19, said instructions further causing said processor to:
form a list of possible proxy addresses comprising at least one address that is on the second copy of the connection table and not on the first copy of the connection table.

21. The computer readable medium of claim 19, said instructions further causing said processor to:
determine if the Internet Web browser is manually configured.

22. The computer readable medium of claim 19, said instructions further causing said processor to:
resolve the URL to an Internet Protocol address.

23. The computer readable medium of claim 22, said instructions further causing said processor to:
compare the Internet Protocol address with the list of possible proxy addresses.

24. The computer readable medium of claim 23, said instructions further causing said processor to:
determine if the Internet Protocol address matches any addresses on the list of possible proxy addresses.

25. The computer readable medium of claim 23, said instructions further causing said processor to:
initiate a proxy request to at least one of the addresses on the list of possible proxy addresses.

26. The computer readable medium of claim 23, said instructions further causing said processor to:
assume that at least one of the addresses on the list of possible proxy addresses is an address of the proxy server.

27. The computer readable medium of claim 19, wherein the Internet Web browser is set for Web Proxy Autodiscovery Protocol.
